(19) United States
(12) Patent Application Publication
(10) Pub. No.: US 2005/0115012 A1
(43) Pub. Date: Jun. 2, 2005

(54) Slideable nonrolling spreader

(75) Inventor: George H. Wakat, St. Paul Park, MN (US)

Correspondence Address: ROBERT J JACOBSON PA, 650 BRIMHALL STREET SOUTH, ST PAUL, MN, 551161511, US

(73) Assignee: Master Stroke Tools, Inc.

(21) Appl. No.: 10/946,903

(22) Filed: Sep. 21, 2004

Related U.S. Application Data
(60) Provisional application No. 60/505,498, filed on Sep. 23, 2003.

(51) Int. Cl. B05C 17/00

(52) U.S. Cl. 15/210.1; 15/231

(57) ABSTRACT

The present slideable nonrolling spreader includes a handle with a corner spreader end and an edger end having a shroud. The spreader includes a relatively wide base that exerts pressure upon a relatively wide piece of spreading material having a generally flat fiber cushion for the loading and unloading of paint. The fiber cushion includes a depth, a width and a height, with the depth being less than each of the width and height.

This application claims the benefit under 35 U.S.C. 119(e) of U.S. Provisional Patent Application No. 60/505,498 filed Sep. 23, 2003, which is hereby incorporated by reference in its entirety into this application.

### FIELD OF THE INVENTION

The present invention relates generally to a slideable nonrolling spreader apparatus, particularly to a spreader apparatus having a relatively great amount of spreading material that comes at one time into contact with a work surface, and specifically to a spreader apparatus having a great amount of spreading material that comes at one time into contact with a work surface where the spreading material is a cushion or network of fibers.

### BACKGROUND OF THE INVENTION

A paint brush unloads paint relatively quickly where the ends of the bristles of the paint brush are not flagged. Flagged paint brushes are extremely expensive. A paint brush, even a flagged paint brush, leaves a trail because a paint brush is rectangular and paints a) like a boat with a square rear end running rearwardly in water so as to leave a relatively great wake (the wake effect) or b) like a plow which leaves a noticeable trail (the plow effect). Also, a paint brush has a relatively great amount of drag. A paint brush, even a flagged paint brush, leaves linear streaks (or linear bumps in the nature of ridges). Loading a paint brush is an art, known by few and practiced by even less. Loading a paint brush involves setting the paint up on the bristles above the flagging (or split ends or catches) without wiping the bristles on the rim of the can. Wiping the bristles on the side of the can to remove “excess” paint, practiced by most homeowners, is actually an unloading. In other words, the homeowner loads and unloads and then attempts to paint.

Further as to a paint brush, a relatively great amount of pressure cannot be applied to a surface with the brush. First, the bristles of a paint brush bend if a relatively great amount of pressure is applied. Second, the handle and hence one's hand is located a relatively great distance from the surface being worked upon such that pressure cannot be immediately applied from the handle to and through the bristles and to the surface. A wall has surface tension of its own. The surface tension is created by dirt and dust and residue on the wall. This surface tension must be overcome for the brushed on paint to coat and stick to the wall.

A paint roller a) leaves a trail on both sides (the wake or plow effect) and b) further makes an orange peel effect between the trails. The high part of the bump does not dry well because it is too thick at such point. As one rolls, the roller lifts the paint from the surface because of the surface tension of the fiber, leaving a series of bumps.

A paint pad includes a foam backing and a layer of bristles glued onto the foam. The foam has some resiliency to permit a give to the layer of bristles as the layer of bristles run over the surface that is being painted. The foam further isolates the layer of bristles from the handle grasped by the user. The foam does not hold paint. The bristles unload paint instantly.

Paint may be sprayed with air, without air (airless), with air assist (air assist airless). Such painting produces the high/low (orange peel) effect. Airless is high volume, high pressure so one cannot create a fine finish. Again, a wall has surface tension of its own. The surface tension is created by dirt and dust and residue on the wall. This surface tension has to be overcome for the sprayed paint to coat and stick to the wall. Further, the transfer efficiency of an air spray gun is about 25% to about 45%, of an airless spray gun is about 60%, of an air assist airless is about 75%, because with these methods much of the paint bounces off. With spray painting, everything in the room to be painted must be covered. With spraying, the end effect is a surface having a plurality of miniature nails sticking out from the surface. Such a rough surface immediately begins to collect dust and dirt. With spraying, a mask is best used.

Electrostatic (automotive) painting does not produce the high/low effect. Electrostatic painting leaves an almost perfectly smooth finish. However, one cannot ground sheetrock or wood or glass or plastic (without first providing an electrostatic coating onto the substrate).

### SUMMARY OF THE INVENTION

A paradigm is a set of assumptions, concepts, values, and practices that constitutes a way of viewing reality for the community that shares them, especially in an intellectual discipline.

The present invention provides a finish that is almost exactly like an electrostatic finish. The finish provided by the apparatus of the present invention is flat.

The present invention is a new paradigm. This paradigm spreads paint:

Evenly and smoothly. The present invention unloads paint evenly and spreads paint evenly and smoothly due at least in part to the high surface tension of the spreading material. The high surface tension is provided by a very fine network of fibers that run in all directions. In contrast, a brush has bristles that line up parallel, causing parallel highs and lows. A roller may have a network, but this network pulls paint away from a wall as it rolls, causing the orange peel (high/low profile) effect. With a high/low effect, the peak of the high or hump or bump may sag under the influence of gravity, causing a run. Paint pads cause highs and lows because the cells of the typical foam paint pad dump paint immediately. With the present invention, paint coverage is maximized with a minimum amount of paint because there are no highs and no lows.

Fast. The present invention spreads paint quickly because one pass is all one needs, because there are no trails to smooth out or re-spread, and because there are no ridges or holidays or misses to recover.

Efficiently. Transfer efficiency is between about 98% and 99.9%. Dripping and loss of paint is minimized because the paint is held in the network of fibers and is unloaded only when pressure is applied to the cushion of fibers from the relatively wide base exerting pressure over the relatively wide cushion of fibers. The only paint that is left behind is the residual in the spreading material.

With no masking. The present invention includes an edger. Hence there is no reason to cover the woodwork or anything in the room to be painted because there is no splatter or dripping such as with brushing, rolling and spraying.

By a direct fixing to the substrate itself, not an indirect fixing to dirt and dust and residue on the substrate. By manually pushing the spreading material onto the wall, with one's hand relatively close to the wall, with a relatively wide surface of spreading material (about three inches), one breaks through the dirt and dust, which is mixed up with the fluid or coating or paint, and applies the fluid or coating or paint directly to the substrate itself. In contrast, a brush has a spreading surface about one-half inch thick and one's hand is relatively far from the wall and the brush bends to minimize the force that one can apply to the wall.

By a fixing with a minimum amount of flow and wetting agents. Flow and wetting agents minimize beading and permit a spreading of the paint. However, flow agents are undesirable in that flow agents cut down on adhesion properties. Another side effect is that the bond between adjacent molecules is lessened such that the skin of the paint is not very strong. The manual energy or pressure supplied by the user of the present invention provides the flow energy to make the paint spread out. While a paint brush user supplies manual energy, such is minimal because the bristles bend and there is only one-half inch of spreading bristles. While a paint roller user supplies manual energy, such is like a rock skipping across the water: only one-eighth of an inch of the roller is making contact with the wall and such one-eighth of an inch is not sliding (which is preferable) but is instead rolling like a wheel.

Another advantage of the present invention is that the handle, base and spreading material can be formed of relatively inexpensive materials such that the spreader is inexpensive to the manufacturer.

Another advantage of the present invention is that the handle and base can be formed inexpensively and engaged in an inexpensive process to the spreading material such that the spreader as a whole is inexpensive to manufacture. The present spreader can be manufactured so inexpensively that the present spreader is intended to be a disposable item, where the fiber network or cushion is not intended to be removable from its attendant base and handle.

The present spreader is a fast spreader or fast brush where such brush includes a cushion or network of fibers instead of bristles. A conventional set of bristles provides no cushion and no network.

The present spreader moves past pad painter technologies. Instead of a pad foam formed of closed or open cells, the present invention uses a network or cushion to spread a coating. Instead of a square or rectangular paint pad or edge painter, the present invention uses a rectangular portion and adds to such rectangular portion a first end having a ninety degree angle and further adds to such rectangular portion a second end having a ninety degree angle. With a ninety degree angle on each of the ends, a user may slide the present spreader backwards, as well as forwards, and keep from catching on the woodwork or ceiling texture. One ninety degree end is structured to create a smooth finish along an edge with no masking. The other ninety degree end can be slid or wiped on siding and paint the face of the siding as well as the under lip of the next row up. Or this other ninety degree end can paint the adjacent wall in a corner without catching or causing a chatter-step action as the tool is wiped along the corner.

A conventional paint pad with rollers or edger with rollers does not paint right up to the edge. Instead, such a rolling device paints only up to the distance permitted by the wheels or rollers that are rolling along the edge. With the present spreader, a relatively thin shroud slides along the trim or woodwork, thereby permitting paint to be applied almost immediately at the edge of the trim or woodwork. If desired, the present network of fibers may be angled outwardly from a fiber backing and in the direction of such trim or woodwork to reach even closer to the trim or woodwork.

The present invention uses fabric, not bristles. Such a choice lowers the cost of the spreader material and increases the loading capacity of the spreader. For example, a knitted fabric has a network to hold more paint than an array of bristles. The fiber network of the present spreader is essentially a tank into which paint is loaded. The fiber network has a great amount of surface area and individual fibers have scales, loops, and other irregularities to increase the amount of surface area and to increase one fiber's interaction with an adjacent fiber. A woven fabric too has a network of fibers to hold paint. For example, a ten denier yarn is combed out to create ten fibers out of each yarn. Given a certain set of factors, a woven fabric may not hold as much paint as a knitted fabric. However, given the same set of factors, the woven fabric may be preferred for some applications because a woven fabric may produce an almost perfectly flat layered application of paint that comes close to duplicating an automotive finish. Woven fabrics and knitted fabrics do not release bristles like a brush or like a pad painter. Woven fabrics and knitted fabrics do not flare out of shape.

With the present spreader and its network of fibers, dripping of paint is minimized relative to a conventional paint brush. With the present spreader and its network of fibers, flipping of paint is minimized relative to a conventional paint brush.

The present spreader includes a hinged shroud that is lifted up before dipping and then put back into place to perform the task of edging in and around woodwork, a ceiling, or base shoe of a typical wall.

The present spreader is about three inches wide and about nine inches in length between the points of the ninety degree ends, thereby creating accomplishing with one stroke of energy what is accomplished with six normal strokes of energy with a conventional paint brush having bristles. Further, a sufficient amount of paint has been brought to the particular area being painted to create a fine flat finish in one pass with no need for a second pass. The present spreader is thus efficient. On glass, with the present spreader having a soft-woven fabric such as a polyester fabric, one pass provides perfect coverage and a perfect film layer. In the past, the only way to obtain such a finish was to spray the paint with a fine-finish tip.

The present spreader may include a cushion or network of fibers that is of various depths. For example, a network of fibers that is about one-quarter of an inch in depth may be used for spreading stain or enamel. A network of fibers that is about three-quarters of an inch deep may be used with a semi-smooth wall or siding.

The present spreader may be used with water-based coatings and oil-based coatings. For example, a polyester/wool blend for the fiber network (or fabric) may be selected for water-based varnish. Such a blend with such a coating spreads with good coverage and causes no air bubbles to form in the varnished surface.

As noted above, the present spreader can be manufactured relatively inexpensively. Such a factor, combined with an endless variety of fiber networks, provides a spreader or set of spreader for an endless variety of applications.

The present spreader is relatively narrow and elongate such that the spreader can cut-in, edge, paint in small or tight areas, on adjacent walls, in corners, and under lips.

Another advantage of the present invention is that air entrainment into the paint or coating is minimized because the coating or painting action is a spread or a wipe or a slide. In contrast, rolling or brushing is an action that entraps or entrains air into the paint or coating.

### BRIEF DESCRIPTION OF THE DRAWINGS

FIG. 1 is a perspective view of the present slideable nonrolling spreader.

FIG. 2A is a side view of the slideable nonrolling spreader of FIG. 1, with a shroud in an operating position.

FIG. 2B is a side view of the slideable nonrolling spreader of FIG. 2A, with the shroud in an out-of-the-way position.

FIG. 3A is a top view of a body of an alternate embodiment of the slideable nonrolling spreader, having threaded receptacles for the reception of an extension rod, and having a pivot attachment for a shroud.

FIG. 3B is a side view of the body of the slideable nonrolling spreader of FIG. 3A.

FIG. 4A is a top view of a body of an alternate embodiment of the slideable nonrolling spreader, having threaded receptacles for the reception of an extension rod, without a pivot attachment for a shroud.

FIG. 4B is a side view of the body of the slideable nonrolling spreader of FIG. 4A.

FIG. 5A is an end view of the body of the slideable nonrolling spreader of FIG. 4A.

FIG. 5B is a section of the body of the slideable nonrolling spreader of FIG. 4A.

FIG. 5C is a section of a body with a fiber cushion or network of fibers engaged to the lower surface of the body, with the lower surface of the body being generally flat and with the lower surface of the fiber cushion or network of fibers curving from a side edge of the fiber cushion or network of fibers to a lower edge of the fiber cushion or network of fibers.

FIG. 6A is a top view of a shroud for the slideable nonrolling spreader of FIG. 3A.

FIG. 6B is a side, partially phantom, view of the shroud of FIG. 6A.

FIG. 7A is a bottom view of the spreader of FIG. 1.

FIG. 7B is a top view of an alternate embodiment of the present spreader.

FIG. 7C is a bottom view of the spreader of FIG. 7B.

FIG. 8 is a detail view of the spreader of FIG. 2A where the fiber network is structured so as to angle into a plane of the shroud so as to paint even closer to a surface that is not to be painted.

FIG. 9A is a section of the spreader of FIG. 1 and shows an alternate form of the spreading material.

FIG. 9B is a section of the spreader of FIG. 1 and shows an alternate form of the spreading material.

FIG. 10 is a section of the spreader of FIG. 1 and shows an alternate form of the spreading material.

FIG. 11A is a top view of a paint tray for the spreader of FIG. 1 or any other spreader of the present invention, where the paint tray is in an open position, and shows a geogrid material in one-half of the paint tray.

FIG. 11B is an end view of the paint tray of FIG. 11A when the paint tray is in a closed position.

FIG. 11C is an end view of the paint tray of FIG. 11A when the paint tray is in an open position.

FIG. 12 is a perspective view of an alternate embodiment of the spreader of FIG. 1.

FIG. 13 is a perspective, exploded view of the spreader of FIG. 12.

FIG. 14A is a perspective, detail, partial view of the spreader of FIG. 12.

FIG. 14B is a perspective, detail view of the spreader of FIG. 12.

FIG. 15A shows a top view of the spreading material of FIG. 12, prior to a fabrication process.

FIG. 15B shows a top view of the spreading material of FIG. 12 during a fabrication process.

FIG. 15C shows a top view of the spreading material of FIG. 12 during a fabrication process.

FIG. 15D shows a top view of the spreading material of FIG. 12 at the end of a fabrication process.

FIG. 16 is a perspective, exploded view of an alternate base portion for the spreader of FIG. 12.

FIG. 17A is a top view of a paint tray for any of the spreaders of the present invention.

FIG. 17B is an end view of the paint tray of FIG. 17A.

### DESCRIPTION OF THE PREFERRED EMBODIMENT

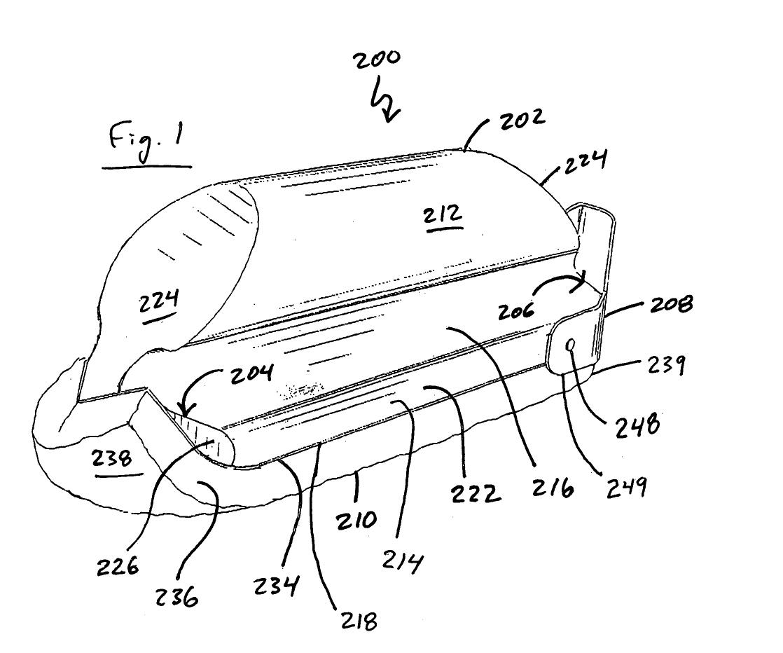

As shown in FIG. 1, reference numeral 200 generally indicates the present slideable nonrolling spreader 200. Spreader 200 generally includes 1) an ergonomic body 202, 2) with the body 202 including a corner spreader end 204, 3) with the body 202 further including an edger end 206, 4) which the edger end 206 including a shroud 208 and 5) a wide surface spreading material 210 engaged on a lower surface of the body 202.

More particularly, as shown in FIG. 1, ergonomic body 202 includes a handle 212, an elongate base 214 to which is engaged the wide surface spreading material 210, and a neck 216 integrally interconnecting the handle 212 and elongate base 214. The handle 212, neck 216 and base 214 are one-piece and integral with each other. Preferably, the handle 212, neck 216 and base 214 are formed from one-piece. Preferably, such one-piece is a polypropylene foam. The polypropylene foam is resistant to solvents and may be extruded. The polypropylene foam is resilient, lightweight and aesthetic.

In section, the handle 212 is generally round or elliptical. The handle 212 fits in the palm of one's hand, with one's fingers curling into the recess provided by the neck 216 and with the thumb of the hand extending along the neck 216 on the other side of the handle 212.

Body 202 is preferably formed of a material that is compressible, resilient, light in weight, and resistant to solvents or solvent-proof. Body 202 may be formed of a foam material or molded from plastic with an axially extending living hinge. The degree of compression is sufficiently great, and the degree of rigidity sufficiently low, such that a hand can firmly and comfortably grip handle 212. The degree of compression is sufficiently low, and the degree of rigidity sufficiently high, such that base 214 remains in generally a planar form for the spreading of paint on a surface.

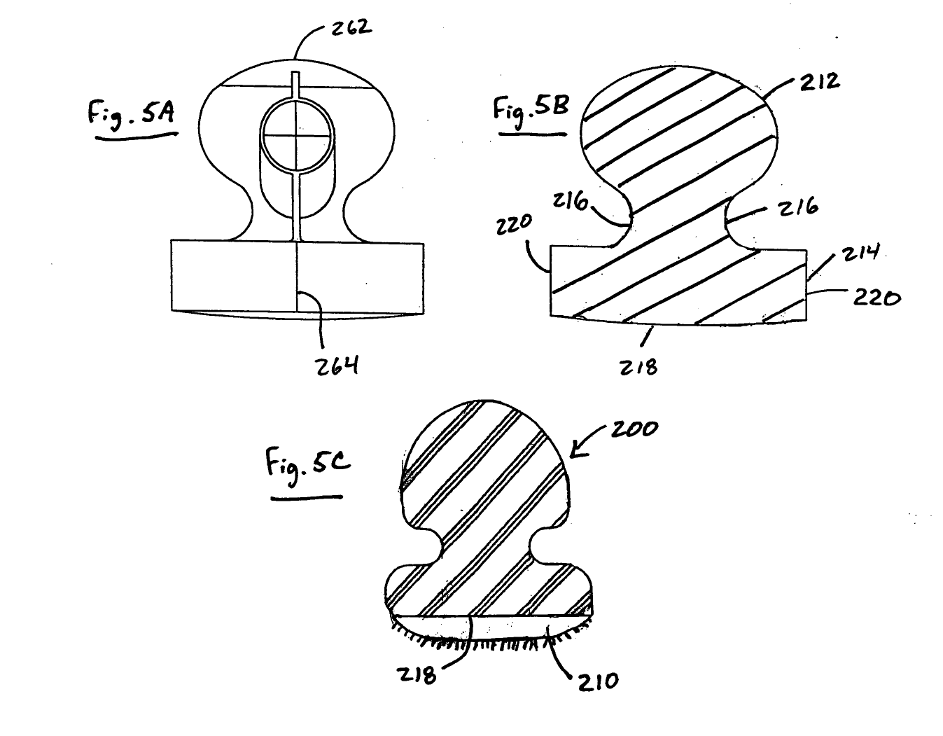

It should be noted that elongate base 214 includes a floor 218. Floor 218 may be generally planar or generally flat (as shown in FIG. 5C). Or floor 218 may include a slight curvature or slight radius that extends from side to side, with the slight curvature or radius being formed along the length of the floor 218. In other words, as shown in FIG. 5B, a section view of the base 214 shows that the floor 218 forms slight arc segment that extends from one side 220 of the base 214 to the other side 220 of the base 214. With the slight curvature or slight radius or slight arc segment, the spreading material 210 too takes up such slight curvature or slight radius or slight arc segment so as to minimize the edges of the spreading material 210 from catching on the surface being worked upon and to maximize a sliding of the spreading material over the surface being worked upon.

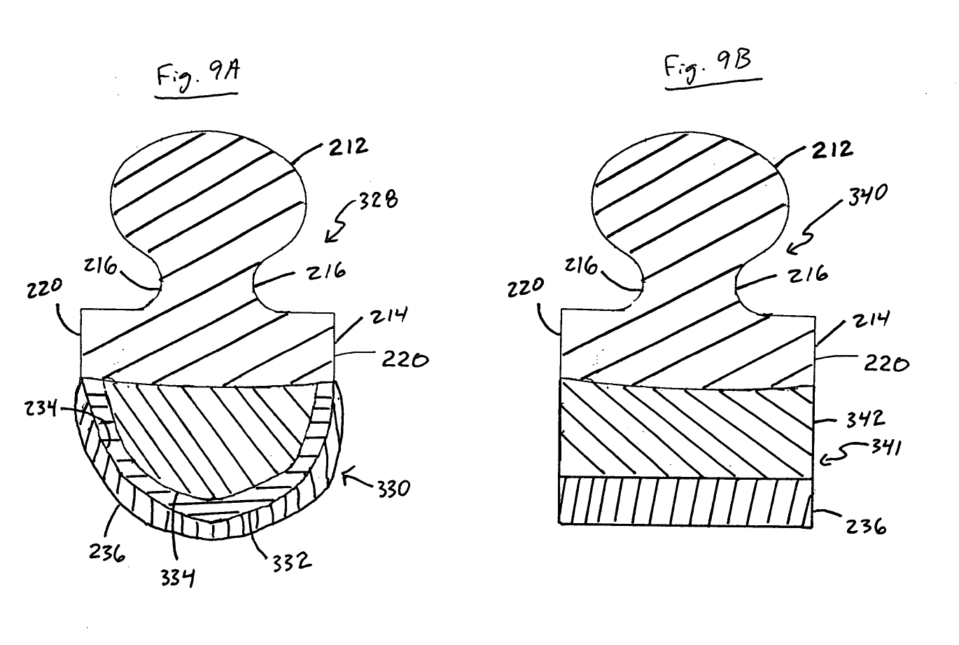

Or, as shown in FIG. 5C, floor 218 can be generally flat and the lower face of the spreading material 210 is curved from a side edge of the spreading material 210 to a medial portion of the lower face of the spreading material 210. The radius to the side edge (or the toboggan effect) relieves surface tension as the spreader 200 slides or is drawn or is wiped across a surface. In contrast, the face of a conventional paint brush is flat and behaves much like a flat bottom boat being lifted up from a body of water, a flat bottom boat being propelled across a body of water, or a flat ended boat being propelled across a body of water, where in each of the cases there is a stupendous amount of surface tension. The present spreader 200, as shown in FIGS. 5A, 5B and 5C, where there is an arc or curved or contoured feature to the sides (and ends if desired) of the spreading material 210 such that the spreader 200 slips smoothly along even a sticky body of fluid (such as paint) whether the spreader 200 is being wiped in a side to side fashion or an end to end fashion. Such a toboggan effect is a contour releasing surface tension effect. The lower face of the spreading material 210 can be rounded throughout so as to have a “peak” as shown in FIG. 9A or can have a curved portion and a flat portion as shown in FIG. 5C.

It should be noted that, in FIG. 5C, the spreading material 210 can include an inner foam and an outer fabric. The inner foam can be reticulated foam and can extend from the floor 218 to the outer fabric. The foam is a reservoir for fluid such as paint. The foam further functions as a bridge to cause the sled or toboggan effect when sliding the spreader 200. The outer fabric can be nylon or other type of fiber network or fiber cushion, preferably of a type disclosed herein.

Sides 220 of the base 214 may run generally normal to floor 218, as shown in FIG. 5B, or the sides may have a radius, as shown by sides 222 in FIG. 1.

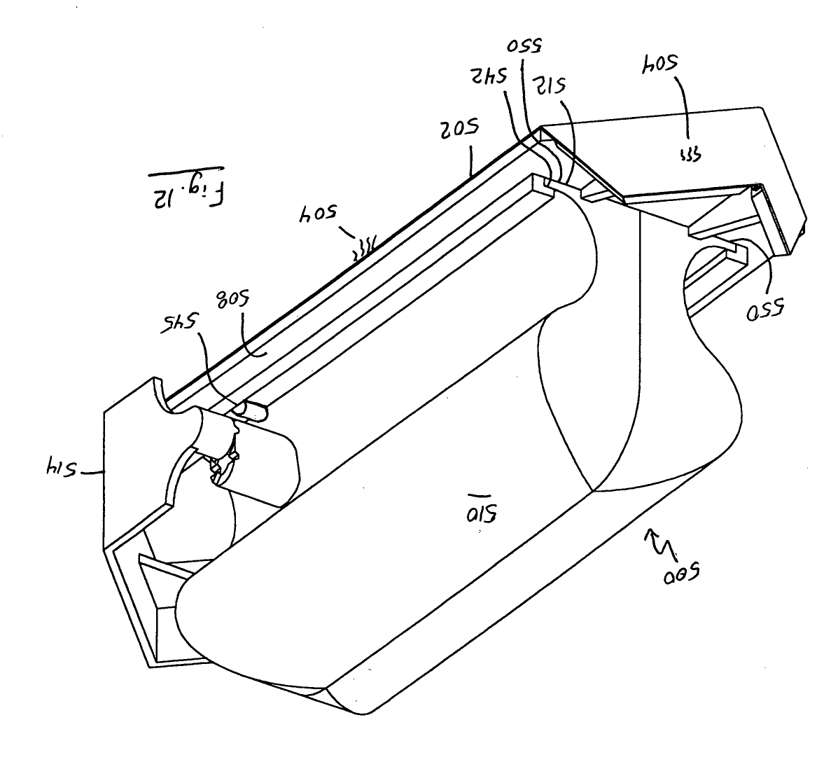

As shown in FIG. 12, the ends 204, 206 of the body 202 slope inwardly from a location near the floor 218 such that a sloping face 224 cuts across a portion of the base 214, neck 216 and handle 212. Such a slope provides a sight line to the surface being worked upon.

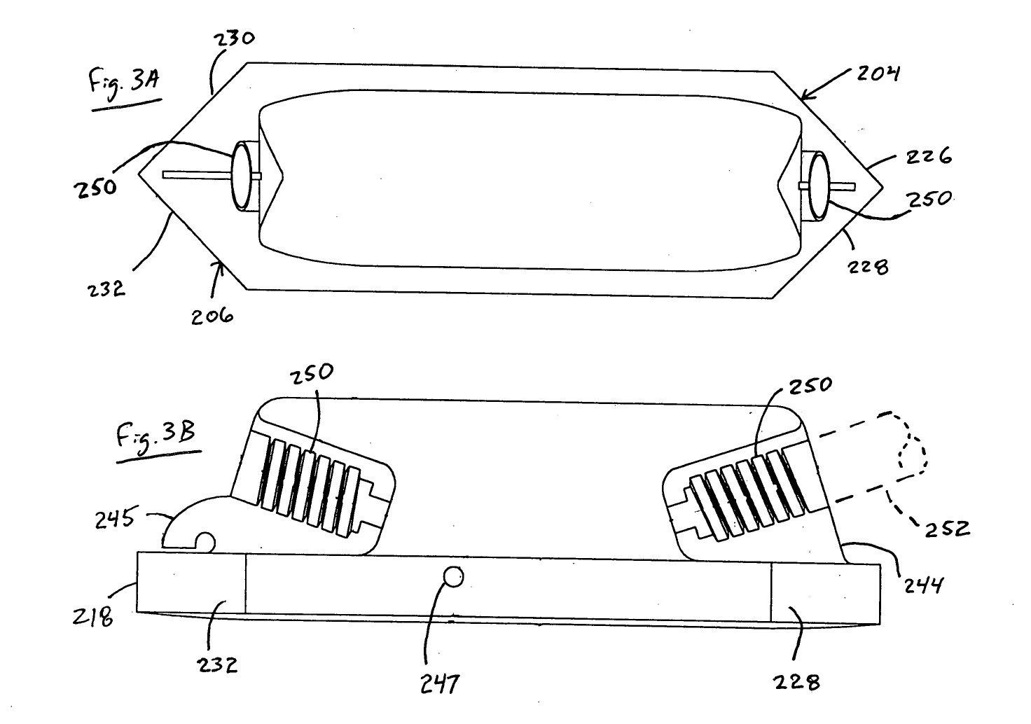

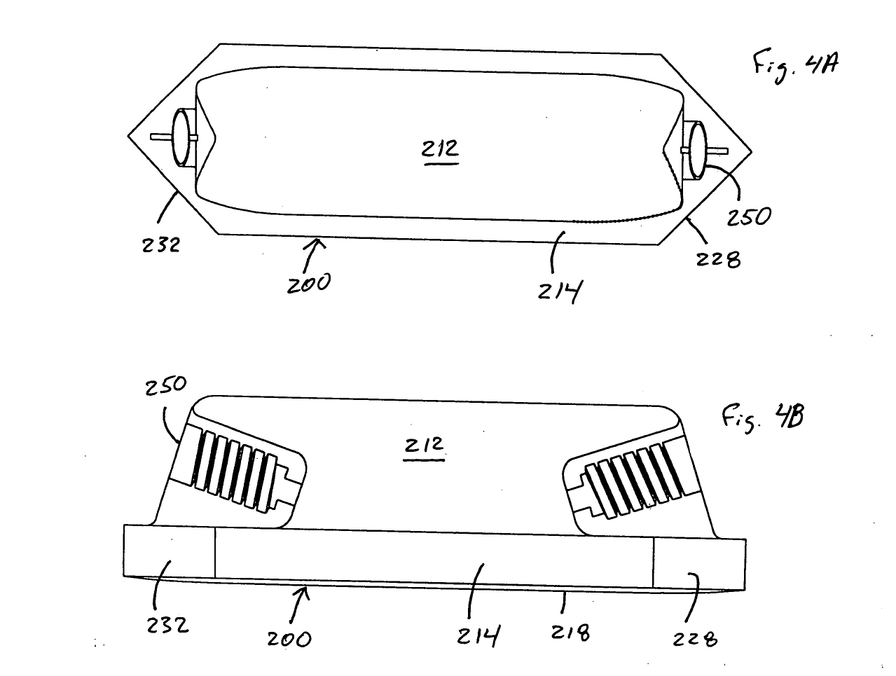

As shown in FIG. 3A, corner spreader end 204 includes first and second end faces 226, 228 extending at a ninety degree angle relative to each other. A great many structures to be painted extend at ninety degree angles relative to each other, and hence the ninety degree relationship between faces 226, 228 is preferred. However, for other applications, faces 226, 228 can extend at other angles relative to each other.

Likewise, as shown in FIG. 3A, edger end 206 includes first and second faces 230, 232 extending at a ninety degree angle relative to each other. Each of the end faces 226, 228, 230, 232 extend generally normal to the floor 218 of the base 214.

Spreading material 210 covers end faces 226, 228 of corner spreader end 204. End faces 230, 232 of edger end 206 are free of spreading material 210.

As shown in FIG. 1, spreading material 210 includes a backing 234 and a fiber portion or cushion 236. Spreading material 210 includes an end portion 238 that curls up over and extends beyond corner spreader end 204. As shown in FIG. 1, spreading material 210 includes an end portion 239 that terminates at the perimeter of the floor 218 of base 214 so as to terminate at the edges of faces 230, 232 of edger end 206.

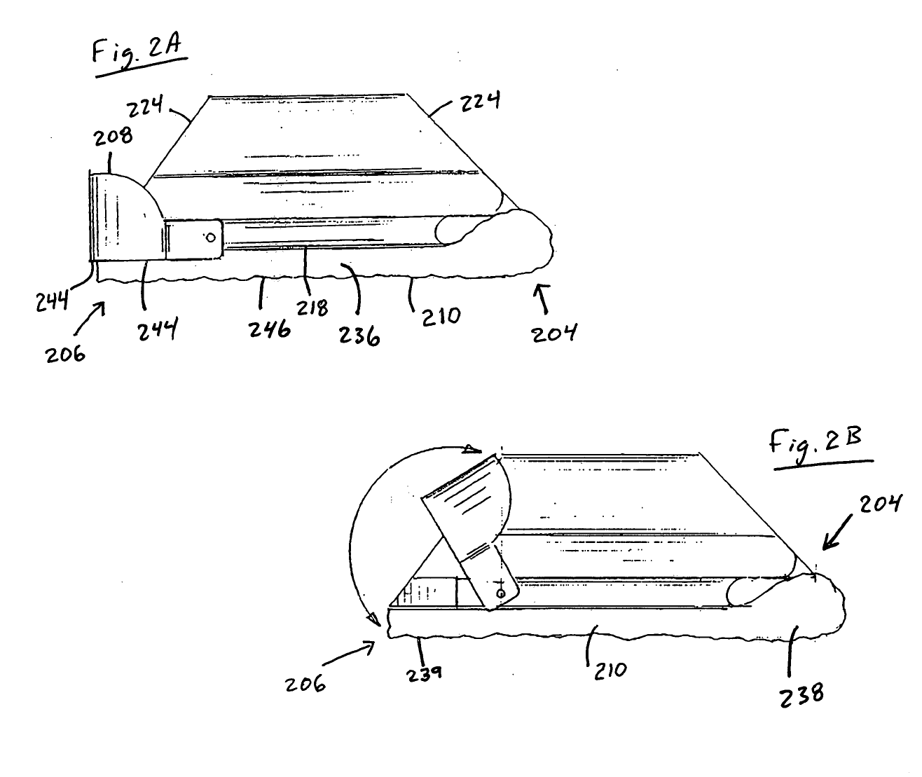

Spreader 200 further includes the shroud 208 that is pivotally engaged to base 214. As shown in FIG. 2A, shroud 208 covers at least a portion of the fiber portion 236 on the edger end 206 when the shroud 208 is in an operating position. As shown in FIG. 2B, shroud 208 may be pivoted to an out-of-the-way position when a faster, but less than perfect, painting operation is preferred.

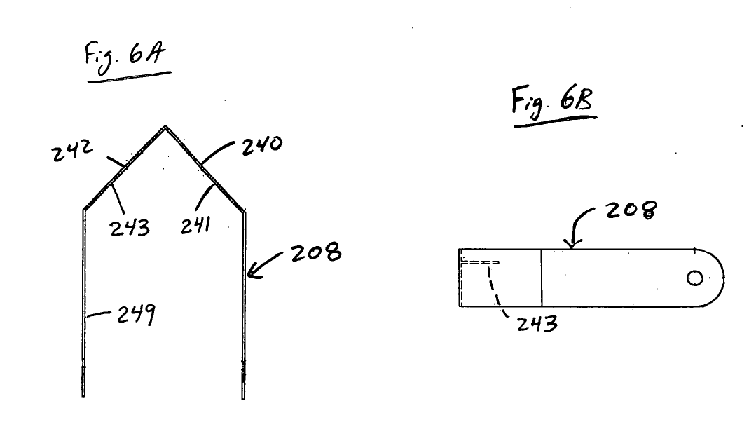

As shown in FIG. 6A, shroud 208 includes first and second protecting plate portions 240, 242 that are disposed at a ninety degree angle relative to each other. Shroud 208 further includes a lower edge 244 that may be disposed exactly or slightly above a face 246 of the fiber cushion 236. Lower edge 244 preferably runs generally parallel to face 246. The lower edge 244 may be disposed, in its operating position, at a position somewhat above the face 246 of the fiber cushion 236, as shown in FIG. 2A. In the operating position, the inner faces 241, 243 of protecting plate portions 240, 242 confront the faces 230, 232 and further confront like portions of the backing 234 and fiber cushion 236 of the spreading material 210. Plate portions 240, 242 are relatively thin such that the fiber cushion 236, containing paint or other coating, can spread paint or other coating up to, but not on, a structure that is not to be painted such that painting without masking or taping can be accomplished. FIG. 2B shows the shroud 208 swung to an out-of-the-way position.

As shown in phantom in FIG. 6B, shroud 208 may include a first catch or detent 243 extending inwardly from the intersection of inner faces 241, 243 for engaging a second catch or detent 245, shown in FIG. 3B, extending from body 202 in the length direction along an upper face of base 218. Second catch 245 is slightly spaced from the upper face of base 218 for permitting reception of a portion of catch 243. Second catch 245 includes a curved upper edge to provide a snapping effect upon such reception. When so snapped in place, shroud 208 is releaseably locked into the operating position. The shroud 208 may take a number of configurations as, for example, a button to unlock a catch or latch. Further, the shroud 208 is preferably readily removable from the base 214 via the pin openings 247 such that another shroud 208 having a lower edge 244 of a different depth, or for a different fiber cushion 236 having a different fiber depth when said the fiber cushion 236 is removably attached to the base 214. In other words, shrouds 208 can be different for fiber cushions 236 of different depths as well as for different applications.

Base 214 includes a pair of pin openings 247, as shown in FIG. 3B. The swinging or pivoting of shroud 208 is permitted via a pair of pins 248 that engage arms 249 of the shroud 208 and that further engage pin openings 247. The pins 248 extend into the base 214 and may include a ball and detent arrangement or other arrangement so as to releaseably lock the shroud 208 in each of the operating and out-of-the way positions.

It should be noted that shroud 208 may be formed so as to include a plurality of holes at different locations such that the depth of shroud lower edge 244 may be adjusted. Further, the shroud 208 may be formed so as to be flipped such that lower edge 244 becomes an upper edge and such that a formerly upper edge becomes a lower edge albeit at a different depth than formerly lower edge 244.

The ends 204, 206 of base 214 define a length of the spreader 200. The sides 222 of base 214 define a width of the spreader 200. The spreading material 210 is engaged, such as by an adhesive, at least to the floor 218 of the base 214. The floor 218 is disposed opposite of the handle 212 such that, via the handle 212, the spreading material 210 can work upon a surface. The length of the spreading material 210 is generally the length of the base 214 such that the spreading material 214 extends generally from end to end of the base 214, with the spreading material 210 extending onto the triangular portions of the floor 218 formed by faces 230, 232 and faces 226, 228. The width of the spreading material 210 is generally the width of the base 214 such that the spreading material 210 extends generally from side to side of the base 214. Accordingly, the spreading material 210 is relatively long and relatively wide to load and unload a relatively great amount of paint and to come into contact with a relatively great amount of a surface at one time. The base 214 generally covers the spreading material 210 such that pressure upon the base 214 translates immediately to pressure upon the spreading material 210 which in turn translates immediately to pressure upon the surface being worked upon to cut through the dirt and dust on the surface and to apply the paint or coat directly to the surface.

The width of the spreading material 210 is preferably between about two and about five inches, more preferably between about two and about four inches, even more preferably between about two and one-half inches and about three and one-half inches, and most preferably about three inches wide.

The length of the base 214, where the length is defined as the distance between the point of intersection of faces 226, 228 and the point of intersection of faces 230, 232, is preferably between about seven and eleven inches, more preferably between about eight and ten inches, and most preferably about nine inches. The length of the spreading material 210 on the floor 218 of the base 214 is preferably the length of the base 214.

Given one spreading material 214 and one paint or coating, the combined width and length of the spreading material 210 is preferably sufficiently great to pick up a sufficient quantity of the paint or coating to provide a relatively fast painting or coating operation for a surface. Given one spreading material 214 and one paint or coating, the combined width and length of the spreading material 210 is preferably sufficiently small to permit an adult male of average size and build to apply sufficient pressure to the spreading material 214 through the handle 212 to cut through any dirt or dust or surface tension on the surface being worked upon to apply the paint or coating directly to the surface.

The spreading material 210 includes generally two structures: the backing 234 and the fiber cushion or network 236. The backing 234 engages the fibers of the fiber cushion 236 and provides a surface for adhesive or other bonding method to fix the spreading material 210 to the base 214. The fiber cushion 236 is a network of fibers where some of the fibers run in a direction toward and away from the floor 218 of the base 214 and where some of the fibers run in a direction crosswise relative to the floor 218 of the base 214. The fiber cushion 236 is preferably a noncell cushion. The fiber cushion 236 is preferably a nonfoam cushion. A network of fibers picks up a relatively great load of paint or coating and deposits such paint or coating when a pressure is exerted upon the network.

The fiber cushion 236 is gently resilient as a whole and each of the individual fibers of the fiber cushion 236 may be elastic and resilient. The fiber cushion 236 includes a relatively great density or concentration of fibers. The concentration of the fiber may be as concentrated as wool, that is, up to generally about 10,000 fibers per square centimeter.

The shape of a fiber of the fiber cushion 236 may be in the form of a hollow or solid tube or cylinder. More preferably, the shape of a fiber of the fiber cushion 236 is irregular such that the fiber includes laterally extending features as well as longitudinally extending features, such as does a wool fiber, which has a three dimensional corkscrew pattern, or helical crimp. Such a fiber occupies more space than if it was a simple tube or cylinder. Further, such a fiber interacts with other fibers to provide networks or pockets to which and in which paint and coatings can cling and collect. Simple tube or cylinder like fibers provide significantly no such networks and pockets. Further, the fiber may include scales or loops on the exterior of the fiber. The scales, loops and other irregular features provide a means for fibers to engage each other to provide a network of fibers. Such a network has a great amount of surface area or wetting area for a coating.

The fiber of the fiber cushion 236 is preferably as flame and shrink resistance as natural wool, has the water/oil repellency of natural wool but is also as absorbent as natural wool, has the anti-static properties of natural wool, and is as resistant to the generation of moths as is natural wool.

The preferred fiber of the fiber cushion 236 is as inherently non-flammable as wool and is as difficult to ignite as wool, has the low flame spreading and heat release properties of natural wool, and further has the little smoke and toxic gas emission properties of wool.

The fiber of the fiber cushion may be a thermoplastic fiber. Some thermoplastic fibers are polyester fibers and polypropylene fibers.

The fiber cushion 236 may include fibers in unblended form or in a form blended with other fibers.

The fiber cushion 236 may include animal fibers such as wool fibers, alpaca fibers, mohair fibers and silk fibers, plant fibers such as cotton fibers, flax fibers, hemp fibers, and jute fibers, synthetic fibers such as nylon, polyester, polyolefin, acrylic, dacron, and rayon fibers. “Shirpa” fabric includes a network of plastic fibers, though for the present spreader “shirpa” fabric leaves fine distortions in a paint film rather than the preferred electrostatic like flat finish.

Among synthetic fibers, nylon is less preferred because nylon has relatively poor surface tension. Among natural fibers, cotton is less preferred because it is absorbent as to some materials.

Among synthetic fibers, polyester fibers are preferred because polyester fibers have relatively good surface tension properties for coating materials.

The fiber cushion 236 preferably does not include bristles. A bristle is stiff. A bristle is a stiff hair. A bristle stands erect. Bristles run generally parallel to each other. A bristle is sharp. A bristle is cylindrical in shape. The present fiber cushion 236 is soft and includes fibers running in generally all directions.

With fibers extending from the backing 234, the fiber cushion 236 is in the nature of a carpet. The fiber cushion 236 has a relatively high recovery rate from substantial deformations. The fiber cushion has a relatively high density. The fiber cushion 236 possesses good dimensional stability under environmental changes and twist-sets well. The fiber cushion 236 has superior handle and resistance to static development.

The fiber cushion 236 may be textured. In texturing, filaments are crimped and looped at random, and finally heat-set, to give the fiber cushion 236 as a whole greater volume or bulk. Such a treatment may provide a permanent helical deformation to the filament in the nature of wool.

The fiber cushion 236 may be a woven fiber cushion or a nonwoven fiber cushion.

The fiber cushion 236 is absorbent as to water, water-based paints and coating, oil, oil-based paints and coatings, polar solvents and nonpolar solvents, latex, coatings for floors, walls, ceilings, and coatings for wood, plaster, cement, sheet rock and other substrates.

Preferably the fiber cushion 236 includes fibers that are merely surface wetted and are not absorbent. In other words, the fiber cushion 236 as a whole is absorbent; however, the individual fiber is preferably not absorbent so that paint or other coating or water does not penetrate the fiber. Some natural fibers are absorbent; others are nonabsorbent. Some synthetic fibers are absorbent; others are nonabsorbent. Some natural fibers may be coated so as to make the individual fiber nonabsorbent. Wool fiber be coated so as to be nonabsorbent.

Unlike wool, the network of fibers 236 does not bunch up or knot up or pack up when wet. It is believed that wool behaves as such because the individual wool fiber is porous. With the present spreader, the individual fiber of the fiber network 236 is preferably nonabsorbent and nonporous to water, oil, latex, resin, paint, varnish, stripper, enamel, paste, glue, polish, stain, and cement.

The fiber network or cushion 236 may be a knitted pile fabric with the pile portion 100% wool not lower in grade than 56's U.S. Standard. Backing 234 may be 100% spun polyester. The finished cloth may weigh as little as 13 ounces per square yard.

Whereas with a conventional paint brush or paint roller a relatively great amount of vehicle (water or oil) must be used, relatively less vehicle is required with the present fiber network 236. Accordingly, painting is more efficient.

Since the fiber network 236 includes individual fibers that are nonporous and nonabsorbent, the fiber network 236 is relatively easy to clean with water or a solvent.

The preferred fiber network or cushion 236 can be provided by woven spreading materials, polyester spreading materials, lint free and woven polyester spreading materials, knitted polyester spreading materials, wool spreading materials, knitted polyester and wool spreading materials, polyester wool blends.

The depth of the fiber network 236 may be from about one-eighth of an inch to about one and one-half inches. For painting conventional sheetrock surfaces, the fiber network 236 preferably has a depth of about one-half inch. For painting textured surfaces, the fiber network 236 preferably has a depth of about three-quarters of an inch. For applying varnish or stain to a surface, such as a rough cedar deck, the fiber network 236 preferably has a depth of about three-quarters of an inch. For applying a coating to block or stucco, the fiber network 236 preferably has a depth of about one and one-quarter inches. In each of these cases, a preferred fiber network 236 is a polyester or acrylic knitted fabric or fiber network.

The fiber cushion or network 236 may be a woven or knitted velour or velvet of, for example, 10-12 denier. A woven velour fiber cushion or network 236 is preferred for varnish and for glass surfaces.

For relatively coarse or rough surfaces, fibers of a relatively large diameter are preferred. For relatively smooth surfaces, finer fibers having a lesser diameter are preferred so as to provide a flatter finish.

The fiber cushion or network 236 is preferably free of lint or includes minimal content of lint. A fiber that includes an acrylic or modified acrylic is one preferred lint-free fiber or fiber having a lint content that has been minimized. A fiber that includes polyester is another preferred lint-free or minimal-lint fiber.

The fiber cushion or network 236 preferably includes a fiber that does not shed.

The fiber cushion or network 236 may be a woven fiber cushion or network 236. The fiber cushion or network 236 may be a nonwoven fiber cushion or network. The fiber cushion or network 236 may be a nonwoven knitted fiber cushion or network 236. A knit is a structure where fibers or yarns are looped around each other, and such loops may or may not be broken. The knit of the fiber cushion or network 236 may be a sliver knit.

The fiber cushion or network 236 may have a denier of about 3 to about 60. The fiber cushion or network 236, or the spreading material 210, may have from about 16 to about 28 stitches per inch. The fiber cushion or network 236 may have from about 40 to about 52 piques per inch.

The fiber cushion or network 236 is preferably a cushion of fibers that works relatively quietly on a surface. Painting with a conventional paint brush or conventional paint roller is a relatively noisy method of painting.

At least some, and preferably all, of the fibers of the fiber network 236 include a coating to reduce drag when the fiber cushion 236 works upon a surface. Such a coating preferably is 1) a silicon based coating or 2) a chemically stable perfluorinated high polymer such as polyhexafluoropropylene or a copolymer of hexafluoropropylene and tetrafluoroethylene such as Teflon® (from DuPont) or Scotchguard® from Minnesota Mining and Manufacturing. Such coatings decrease the surface tension of the fiber network 236 so as to decrease the drag of the fiber network 236 over a surface being worked upon. At the same time, a fiber network 236 treated with such a coating maintains a large capacity for loading paint. Fluoro polymer and silicon coatings, as indicated above, further provide the individual fiber with a nonporous and nonabsorbent structure to permit the fiber to retain its resiliency. In other words, prior to fibers of the fiber cushion being coated, the fibers have a given drag upon a given surface with a given pressure. However, after each of the fibers are coated with a drag reducing coating as indicated above, then the given drag upon said given surface with said given pressure is reduced.

As indicated above, with the slight curvature or slight radius or slight arc segment, the spreading material 210 too takes up such slight curvature or slight radius or slight arc segment so minimize the edges of the spreading material 210 from catching on the surface being worked upon (minimizing drag) and to maximize a sliding of the spreading material over the surface being worked upon. Accordingly, the noncell and nonfoam fiber cushion 236 may be one of i) generally planar between the sides 222 and ii) slightly curved between the sides 222.

The spreading material 210 preferably includes a depth less than each of width and length of the spreading material 210 (or less than each of the width and length of the base 214), such as less than one-half or less than one-third of the width of the spreading material 210. The depth of the spreading material 210 is preferably between about 0.1% and 50% less than the width of the spreading material 210 with a more preferred range being between about 10% and 45%, with an even more preferred range being between about 20% and 40%, with an even more preferred range being between about one-fourth (generally 25%) and about one-third (generally 33%) less than a width of the spreading material 210. The width of the spreading material 210 is preferably less than a length of the spreading material 210, more preferably less than about one-half or 50% of the length of the spreading material 210, more preferably less than about 40% of the length of the spreading material 210, and most preferably about one-third of the length of the spreading material 210.

End 204 of base 214 is designated a first end. This first end is the corner spreader end and includes spreading material 210 on each of the faces 226 and 228 such that paint may be applied on three surfaces at the same time, with each of the three surfaces being normal to each of the other two surfaces. Face 226 is normal to each of face 228 and the face of the spreading material 210 (which is generally flat or slightly curved).

End 206 of base 214 is designated a second end. This second end is the edger end and includes the shroud 208. The shroud 208 can ride along, for example, wood trim and shield the wood trim from the spreading material 210. End 206 includes two faces 230, 232 extending at generally right angles to each other and at generally a right angle relative to the floor 218 (which is generally flat or slightly curved). The spreading material 210 terminates immediately at the floor portions of floor 218 that lead immediately into the faces 230, 232 such that the spreading material 210 can come as close as possible to, for example, wood trim without painting the wood trim. The two faces 230, 232 are free of spreading material 210.

As indicated above, the shroud 208 is engaged to the body 202. The shroud 208 includes a pair of inner faces 241, 243, as shown in FIG. 6A, and a lower edge 244, as shown in FIG. 2A. Shroud 208 is movable to an operating position, as shown in FIG. 2A where the inner faces 241, 243 confronts an end of the spreading material 210 and where the edge 244 is disposed beyond floor 218 of base 214 and confronts the end of the spreading material 210. The shroud 208 is movable to an out-of-the way position as shown in FIG. 2B where the inner faces 241, 243 are out of the way of the end of the spreading material 210. As indicated above, shroud 208 is pivotally engaged to body 202.

Body 202 includes neck 216 disposed between handle 212 and base 214. As shown in FIG. 1 and FIG. 5B, neck 216 includes a neck having a width less than a width of each of handle 212 and base 214. As shown in FIG. 1, each of the handle 212, neck 216, and base 214 is elongate in a first common direction. Handle 212 confronts the base 214 which in turn confronts the base 214 which in turn confronts the spreading material 210 such that control of handle 212 translates immediately to control of the spreading material 210 and such that, with pressure upon the handle 212, the pressure is relatively close to the surface being worked upon such that the spreading material 210 breaks through dirt and dust and other contaminants on the surface and applies coating directly to the surface instead of to dirt, dust, contaminants and other fine particles on the surface.

The body 202 includes a pair of threaded receptacles 250 for receiving an extension or extension handle 252, as shown in FIG. 3B. Each of the threaded receptacles 250 extend inwardly from inclined faces 224 and themselves extend at an oblique angle relative to the floor 218 of base 214. Extension handle 252 includes a cooperating threaded end for engaging threaded receptacles 250. With extension handle 252, spreader 200 may work upon relatively distant surfaces such as ceiling or the upper portions of relatively tall walls.

As shown in FIG. 5A, body 202 may be relatively hollow, formed by molding two half-sections having a living hinge 262, and engaging the two half-sections via a seam 264. As shown in FIG. 5B, body 202 may be relatively solid, and such a solid body 202 may be formed by molding.

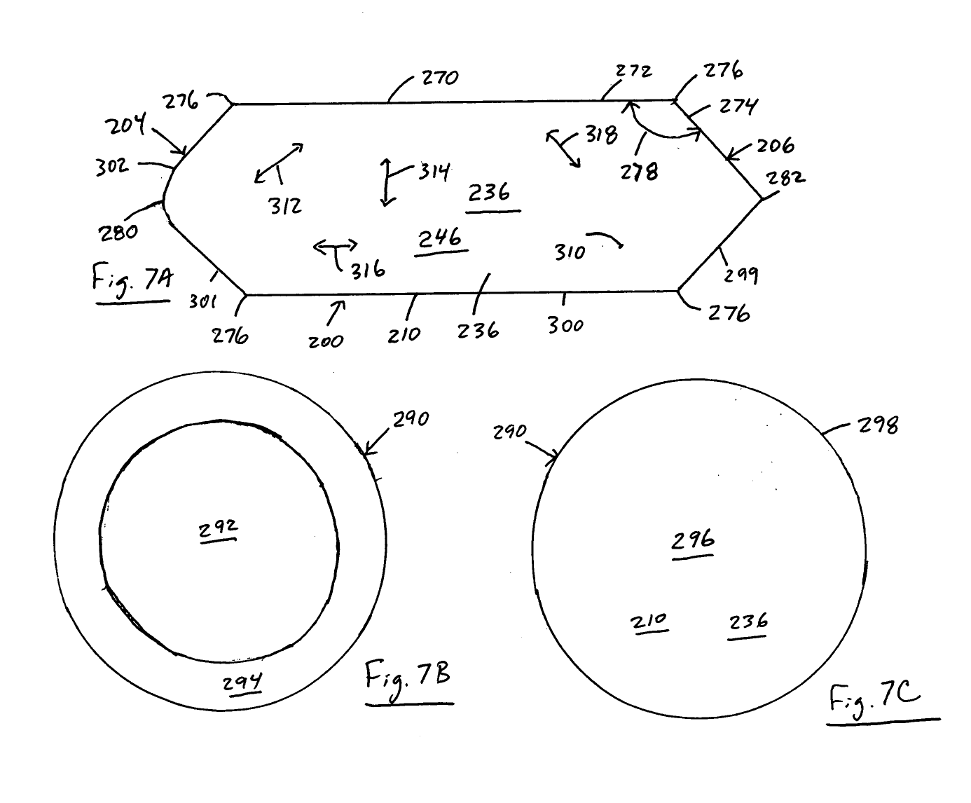

As shown in FIG. 7A, spreading material 210 includes a peripheral face 270 having at least two generally straight faces 272, 274 meeting at a point or edge 276. The inner angle 278 between the faces 272, 274 is greater than ninety degrees to minimize the problematic wake or plow effect described above. Spreader 200 having a spreading material 210 of the structure shown in FIG. 7A provides four such points or edges 276 such that the wake or plow effect is minimized in most directions. It is noted that portion 280 of peripheral face 270 is curved, since spreading material 210 is being turned up to engage faces 226, 228, and such curved portion 280 provides minimal wake or plow effect. Even point or edge 282, formed by edges running normal to each other, generates minimal wake or plow effect since each of its adjacent points or edges 276 are formed by edges at an angle greater than ninety degrees.

From FIG. 7A, a bottom view, it can be noted that fiber cushion 236 includes a generally rectangular portion defined by the four points or edges 276, a first generally triangular portion at one end defined by point or edge 276 on one side, point or edge 276 on the other side, and point or edge 280 (the corner spreading end having faces 301, 302), and a second generally triangular portion at the other end defined by point or edge 276 on one side, point or edge 276 on the other side, and point or edge 282 (the edger end having faces 274 and 299).

In other words, the slideable nonrolling spreader 200 includes base 214 that in turn includes a rectangular portion (to support the rectangular portion defined by edges 276) and two generally triangular portions (to support the triangular portions of the fiber cushion 236 referred to above), with the triangular portions of the base 214 being opposite of each other, with each of the triangular portions of the base 214 being set at opposite ends of the rectangular portion of the base 214, such that one of the triangular portions of the base 214 forms a support for the fiber cushion corner spreader end and such that the other of the triangular portions of the base 214 forms a support for a fiber cushion edger end.

Inner angle 278, shown in FIG. 7A, is preferably 135 degrees, and each of the other corresponding angles (having points 276 thereon) are preferably 135 degrees. Such an angle relative to face 272 if extended is a 45 degree angle. Such an arrangement provides 90 degree angles to the ends or triangular portions.

As shown in FIG. 7A and as indicated above, the spreading material 210 includes a peripheral face 270. This peripherally running face includes face 272, face 274, face 299, face 300, face 301 and face 302. The angle between faces 272 and 274 is 135 degrees. The angle between faces 274 and 299 is ninety degrees. The angle between faces 299 and 300 is 135 degrees. The angle between faces 300 and 301 is 135 degrees. The angle between faces 301 and 302 is 90 degrees. The angle between faces 302 and 270 is 135 degrees. Face 274 is generally coplanar with face 230 of base 214. Face 299 is generally coplanar with face 232 of the base 214. Faces 270 and 300 run into sides 222 of the base 214 and are generally coplanar with such when sides 222 are generally flat. Faces 301 and 302 are somewhat curved in shape and are positioned beyond faces 226 and 228 of base 214 when backing 234 is engaged on faces 226 and 228.

As indicated above, the spreading material 210 includes generally two structures: the backing 234 and the fiber cushion 236. The fiber cushion 236 is a network of fibers where some of the fibers run in a direction toward and away from the floor 218 of the base 214 and where some of the fibers run in a direction crosswise relative to the floor 218 of the base 214. The direction to and away from floor 218 is indicated by point 310 in FIG. 7A. Crosswise directions relative to floor 218 are indicated by reference numbers, 312, 314, 316, and 318. Further crosswise directions extend obliquely to and from floor 218. Generally, a network of fibers includes fibers running in a plethora of directions and the fiber cushion 236 includes such a network of fibers. The body of the fiber network or cushion 236 of the present spreading material of the present invention is considerably great and includes relatively great capability for loading and unloading of paint.

In operation, prior to using the spreader 200, a surface to be painted or coated may be cleaned and is conventionally cleaned of dirt and dust. With the present spreader 200, this step assumes less importance because manual pressure is utilized and because full manual pressure utilized, not manual pressure lessened by a great degree by a bending of the conventional bristles of a brush. With such full manual pressure, the coating or paint is driven through the dirt and the dust and directly to the surface to be coated. Then the spreader 200 is dipped into a paint can directly or into a paint tray to pick up paint. The fiber cushion 236 picks up a relatively great amount of paint. Then the spreader 200 is slid or swept across a surface. As the spreader 200 is pressed and slid against the surface, paint is driven through dirt and dust and deposited directly onto the surface without entrapment of air therein. As the spreader 200 is pressed and slide against the surface, minimal or no wake or plow effects can be seen, by virtue of the multi-point cushion fiber face 246 (having four points or four face intersections 276, end or apex or point or face intersection 280, and point or face intersection 282). Along the vertical intersection of two horizontal walls, corner spreader end 204 may be used. Along wood trim that is not to be coated, edger end 206, with shroud 208 in either the operating or out-of-the-way position, may be used. The dipping and sliding (coating) operation is repeated until the surface to be worked upon is coated. Then the cushion fiber 236 is cleaned, such as with water or a solvent, and stored for subsequent use.

An alternate embodiment of the invention is shown by spreader 290 in FIG. 7B. Spreader 290 includes a handle 292 having a round periphery and a base 294 having a round periphery. As shown in FIG. 7C, spreader 290 further includes a piece 296 of spreading material 210 having the fiber cushion 236 with the network of fibers. This piece 296 of spreading material 210 includes a round periphery or round edge 298 that produces a minimal wake or plow effect when the spreader 290 is slid on a surface in any direction.

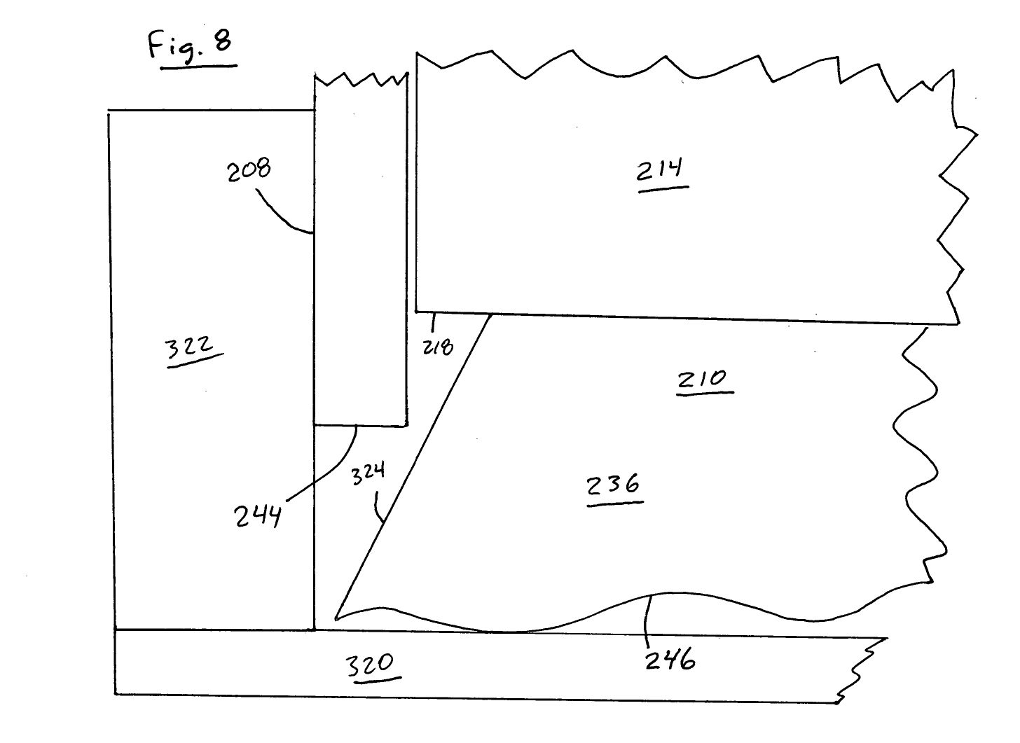

As shown in FIG. 8, the fiber network or cushion 236 may be cut or formed to extend beyond or outwardly of base 214 to apply paint on a wall 320 immediately along a surface of a trim or molding 322, where the shroud 208 is running along the trim or woodwork 322. As shown in FIG. 8, an edge 324 of fiber network 236 is oblique to the floor 218. Further, a portion of the edge 324 is generally in a plane defined by the shroud 208 and terminates prior to a plane defined by an outer surface of the shroud 208. The angled edge 324 tends to flow paint into the area immediately adjacent to the trim 322 in the manner of the wake of an angled slice of a boat.

As shown in FIG. 9A, as to a spreader 328, spreading material 210 is replaced by a spreading material 330. Spreading material 330 includes the fiber network 236 as the semi-circular outer layer and a reticulated foam layer 332 as a semi-circular inner layer. Spreader 328 further includes an added base portion 334 having a semi-circular outer surface. The base portion 334 is preferably formed of the same material, polypropylene foam, as the base 214. Base portion 334 may be one-piece and integral with base 214. Each of the fiber network 236 and reticulated foam layer 332 is elongate to run the length of the base 214. The ends of the fiber network 236, reticulated foam layer 332 and base 214 may be substantially planar or form triangular like or pyramidal like ends. Backing 234 on the fiber network 236 is perforated to permit fluid, such as a coating or paint, to be exchanged between the fiber network 236 the reticulated foam 332, which is a reservoir for the coating or paint to be spread by spreading material 330. With the radius or curvature of the fiber network 236 on spreader 328, a coating such as a waterproofing coating may be directed into depressions or holes or irregular surfaces of basement walls.

As shown in FIG. 9B, a spreader 340 replaces spreading material 210 with spreading material 341. Spreading material 341 includes, as an inner layer, a geogrid material 342 and, as an outermost layer, the fiber network or cushion 236. At one surface, the geogrid material 342 is engaged to base 214. At an opposing surface, geogrid material 342 is engaged to backing 234 of fiber network or cushion 236. Backing 234 may or may not be perforated. Geogrid material 342 is a resilient three dimensional network or mesh formed preferably of plastic strands or filaments. As to the geogrid material 342, the following U.S. patent Numbers are hereby incorporated by reference in their entireties: 1) the Harford U.S. Pat. No. 5,669,796 issued Sep. 23, 1997 and entitled Geogrid Composed Of Polyethylene Terephthalate And Polyolefin Bicomponent Fibers; 2) the Van Vliet et al. U.S. Pat. No. 6,312,198 issued Nov. 6, 2001 and entitled Geogrid And Civil Engineering Structure Comprising Such A Geogrid; 3) the Mercer U.S. Pat. No. 6,423,394 issued Jul. 23, 2002 and entitled Plastics Material Mesh Structures.

As to geogrid material 342, a geogrid is a manufactured polymer construction characterized by large openings made by either coating woven or knit products to form a grid, welding oriented strands to form a grid, or punching holes in flat sheets then drawing them to align the polymer molecules. Geogrids generally are made up of a “lattice” of longitudinal and transverse straps or strands bonded together at an angle, preferably of between 80 degrees and 100 degrees. Especially preferred are geogrids where the straps or strands are bonded together through the polymer of the straps or strands themselves, since such grids can be made comparatively easily without recourse to glue or other adhesives. Geogrids dry easily and are weatherproof.

A spreader 340 having such geogrid material 342 as a resilient inner layer permits the fiber network 236 to better follow irregular surfaces or slide or squeezed into tight areas, such as found on surfaces of basement walls or surfaces of stone walls. Spreader 340 may be used in “patting” operations where the coat or paint is applied by patting the paint on a surface.

As to spreader 340, geogrid material 342 may be replaced by a reticulated foam and/or the fiber network or cushion 236 may be replaced by an abrasive material such as sandpaper, a sanding foam material, a cutting foam material, or a material where the abrasive surface is the outermost surface. Such abrasive material can be abrasive to sheet rock, plaster, and wood. Such abrasive material can be abrasive when wet with water or other fluid.

The ends of spreader 340 can be formed like the ends of spreader 200. One end is an edger end. The other end is a corner spreader end.

It should be noted that the fiber cushion or network 236 can have, as a base, a relatively hard base (i.e., the base 214), a foam or reticulated base (i.e., portion 342 where such portion includes foam or reticulated foam), a relatively soft base (i.e., portion 342 when such is a geogrid material or portion 342 when such is foam), a relatively wide base (i.e., any of the bases noted above and below), and an expandable or squeezable base that takes up a minimum of space (i.e., the geogrid layer 342).

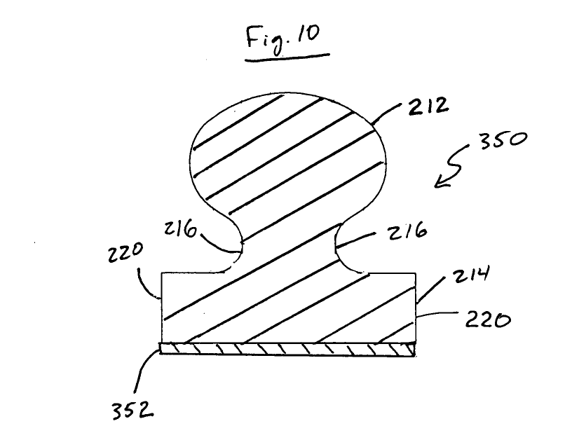

As to a spreader 350, shown in FIG. 10, spreading material 210 may be replaced by a layer 352 of abrasive material or a layer 352 having an outer surface of abrasive material. The abrasive material can be sandpaper, a sanding foam material, or a cutting foam material. Such abrasive material can be abrasive to sheet rock, plaster, and wood. Such abrasive material can be abrasive when wet with water or other fluid. The ends of spreader 350 can be formed like the ends of spreader 200 where one end is an edger end and where the other end is a corner spreader end.

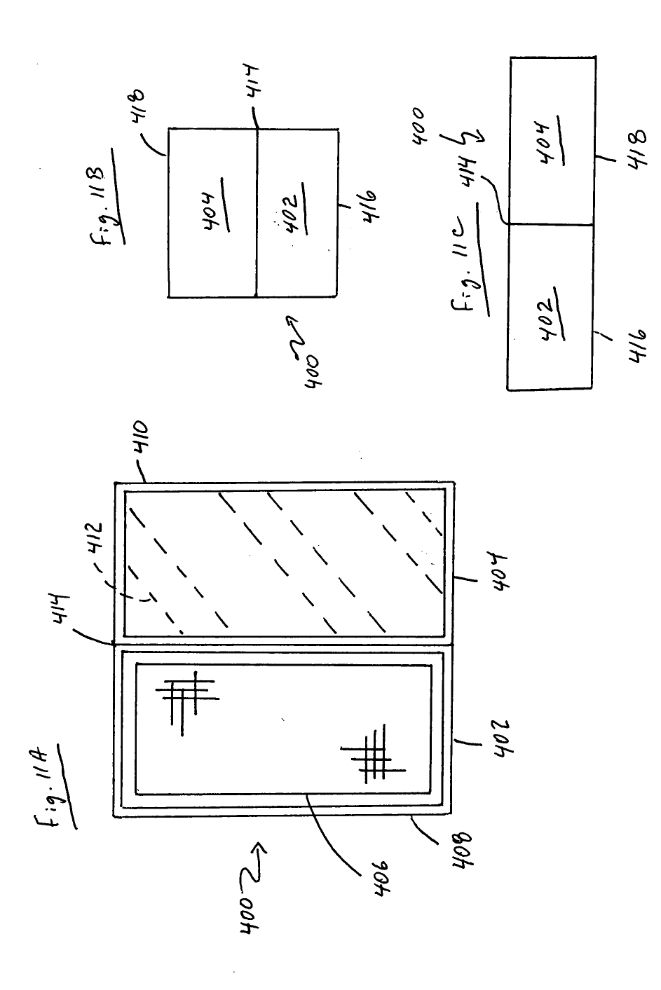

A paint tray 400 is shown in FIGS. 11A, 11B and 1C. Paint tray 400 includes an elongate dipping portion 402 and an elongate cover portion 404. Each of dipping portion 402 and cover portion 404 is generally parallelepiped in shape.

Portion 402 is receptacle shaped and may include a piece of mesh 406 also having a parallelepiped shape. Mesh 406 can be a piece of geogrid material such as the geogrid material 342 described above. Paint or another coating may be poured into dipping portion 402 with or without mesh 406 therein. If mesh 406 is contained therein, the fiber network 236 of any of the above spreaders may be pushed down into the mesh 406 to work the paint or other coating up into the fiber network 236. Then the bottom surface of the fiber network 236 can be skimmed across the upper surface of the mesh 406 to skim off paint that would otherwise drip from the spreader as the spreader is being carried to the surface to be painted. Dipping portion 402 includes a peripheral endless lip 408.

Cover portion 404 is receptacle shaped and includes a peripheral endless lip 410. Spreader 200, or any of the other spreaders of the present invention, can be placed laterally across portions of one or more of the lips 408, 410 such that lips 408, 410 act in the nature of platforms. Cover portion 404 can further include, as indicated in phantom in FIG. 11A, platform portions 412 running laterally and obliquely between portions of lip 410 such that spreader 200, or any other spreader of the present invention, can be set in a longitudinal position on portions 412 within peripheral lip 410.

Tray 400 is preferably molded. Dipping portion 402 and cover portion 404 are one-piece and integral with each other via an elongate living hinge portion 414 and the height of the portions 402 and 404 are generally equal to one another such that, as shown in FIG. 1C, when the tray is in the open position, a bottom 416 of dipping portion 402 lies in generally a common plane with a top 418 of cover portion 404 such that, when on a surface, dipping portion 402 supports itself and cover portion 404 supports itself.

It should be noted that the present spreader may be sold in a self contained kit, where the kit includes the tray 400, the mesh 406, and one of the spreaders of the present invention. When stored, the mesh 406 rests in dipping portion 402 and the spreader rests on top of the mesh 406, with the tray 400 being stored in the closed position shown in FIG. 11B, with the cover portion 404 being closed over the spreader, and with the lips 408, 410 confronting each other via a clip, adhesive, or shrink wrap about the closed tray 400 itself. Such a kit preferably does not include such platform portions 412.

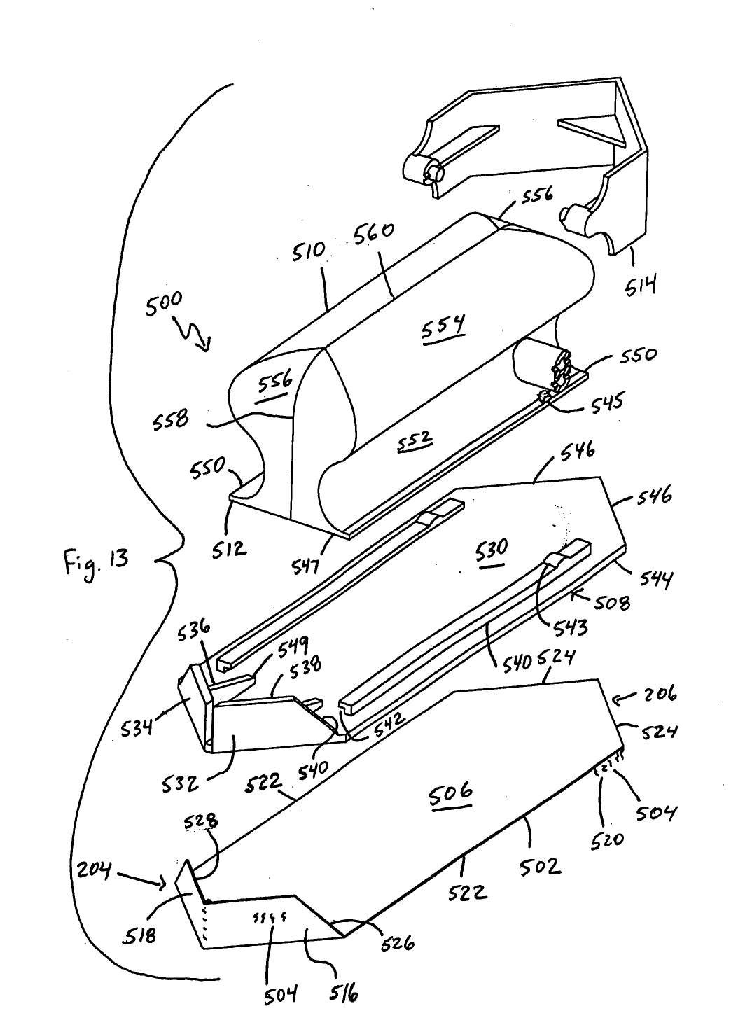

An alternate embodiment of the spreader of the present invention is shown in FIGS. 12, 13 and 14. This alternate embodiment is indicated in general by reference numeral 500 and includes, as shown in the exploded view of FIG. 13, spreading material 502 that includes a fiber cushion 504 and a backing 506, a base portion 508 that is permanently engaged to the spreading material 502, a handle 510 having an integral second base portion 512, and a shroud 514.

Spreading material 502 includes the corner spreader end 204 and the edger end 206. The corner spreader end 204 includes a first face 516 of the fiber cushion 504 and a second face 518 of the fiber cushion 504. The faces 516 and 518 are disposed at about ninety degrees relative to each other and to a base face 520 running to and between the corner spreader end 204 and the edger end 206.

Spreading material 502 includes a periphery formed by elongate side edges 522 running on either side of the base face 520, edges 524 formed at about a ninety degree angle relative to each other and obliquely relative to their respective side edges 522, and edges 526, 528 that form a portion of each of the faces 516, 518. Edge 526 runs obliquely and upwardly relative to base face 520 and edge 528 runs generally coplanar relative to base face 520.

First base portion 508 is permanently engaged to spreading material 502 such as by a sonic welding technique. First base portion 508 includes a flat section 530 having a flat face or flat underside for confronting and engaging the backing 506 of the spreading material 502. First base portion 508 further includes a pair of ears 532, 534 rigidly formed at a right angle to each other and at right angles to the flat section 530. Each of the ears 532, 534 is supported via a brace 536 integrally formed between one respective ear and flat section 530. Ear 532 confronts and engages the portion of the spreading material 502 having face 516, and ear 534 confronts and engages the portion of the spreading material 502 having face 518. Each of the ears 532, 534 includes an edge 538 that is generally coplanar with base section 530 and that runs flush with edge 528 of spreading material 502 and further includes an edge 540 that runs obliquely to base section 530 and runs flush with edge 526 of spreading material 502.

First base portion 508 further includes a pair of tracks 540 running longitudinally or in the lengthwise direction on flat section 530. Each of the tracks 540 is formed in the nature of an angle iron so as to be L-shaped and such that each of the tracks 540 forms a groove 542 with the upper face or upper side of flat section 530. Grooves 542 oppose each other so as to receive therein second base portion 512 which is integrally formed with handle 510. Each of the tracks 540 further includes a nub receptor 543 for receiving a nub 545 formed on second base section 512 and for locking second base portion 512 in place on first base section 508. When so locked, an end 547 of second base portion 512 confronts ends 549 of braces 536.

Flat section 530 further includes elongate side edges 544 that run parallel to each other and to the tracks 540 and that run flush with side edges 522 of spreading material 502. Flat section 530 further includes edges 546 disposed at right angles relative to each other and obliquely relative to side edges 522 and that run flush with edges 524.

First base portion 508 is a molded piece such that flat section 530, ears 532, 534, braces 536 and tracks 540 are one-piece and integral with each other.

As indicated above, second base section 512 is integral with handle 510. Second base section 512 includes a pair of rails 550, extending parallel to each other, and sized in a spaced apart width and sized in height for engaging the tracks 542 such that the rails 550 are slideable into and out of tracks 542 in a friction fit arrangement, with the friction fit arrangement being lockable via nub 545 locking into nub receptor 543.

Handle 510 includes an elongate neck 552, lesser in width than the distance between rails 550, and lesser in width than a palm confronting body 554. Body 554 has a pair of end faces 556 that slope inwardly. Body 510 is preferably molded in two portions that are mirror images of each other, and then adhered together, along a line 558, with a line 560 indicating a living hinge that is integral with each of the mirror molded portions.

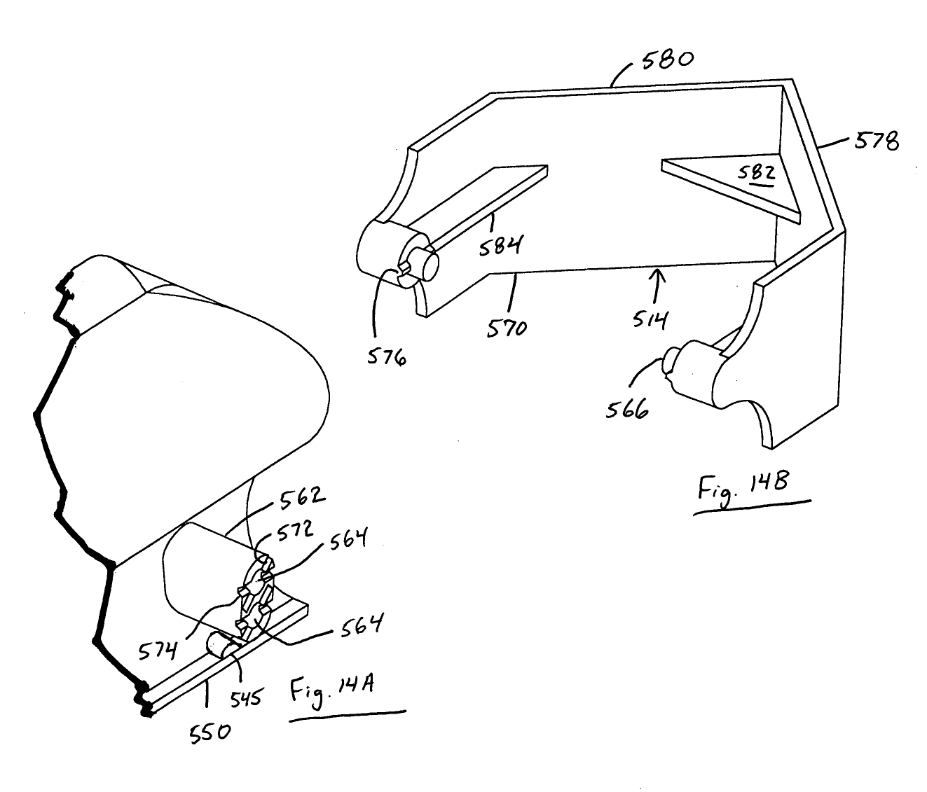

Handle 510 further includes a pair of shroud pin receptor housings 562 extending integrally and laterally from the neck region 552. As shown in FIG. 14A, each of the receptor housings 562 includes a pair of pin receptors or openings 564 for receiving a pin 566 of shroud 514. Engagement of pin 566 in one or the other of the pin receptors 564 raises and lowers a lower edge 570 of shroud 514 relative to the face 520 of the fiber cushion 504 such that fiber cushions 504 having a lesser or greater depth may be used. Further, the engagement between pin 566 and receptor 564 is a removable engagement such that another shroud 514 having a different height relationship between pin 566 and lower edge 570 may be used to provide even further combinations or variables for fiber cushions 504 of greater and lower depths and shrouds 514 having lower edges 570 of greater or lower relative height.

Each of the receptor housings 562 has, about each of the pins 566, a detent arrangement where aligned faces 572 position shroud 514 in an out-of-the-way position and where aligned faces 574 position shroud 514 in an operating position where lower edge 570 is disposed generally in the plane of fiber cushion 504 and perhaps in the plane of the lower face 520 of the fiber cushion 504. Aligned faces 572, 574 cooperate with respective projections 576 axially extending from pin 566. Each of the projections 576 has a pair of angled faces leading into a flat head.

Shroud 514 is an integral molded piece such that pins, 566, via faces 578, 580 each being resilient on its own accord or via faces 578, 580 being resilient relative to each other, are resiliently drawable to and apart from each other. Pins 566, via faces 578, 580 each being resilient on its own accord or via faces 578, 580 being resilient relative to each other, are biased toward each other so as to keep shroud 514 locked in housing 510 and so as to keep projections 576 locked at the desired position in the detent arrangement that includes faces 572, 574.

Faces 578, 580 of shroud 514 shield a surface, such as woodwork, from edges 524 of fiber cushion 504 such that coating or paint on fiber cushion 504 is not transferred to such woodwork. Faces 578, 580 may be relatively thin, such as paper thin. Portions 582, 584 are braces that lend a factor in controlling the rigidity of shroud 514.

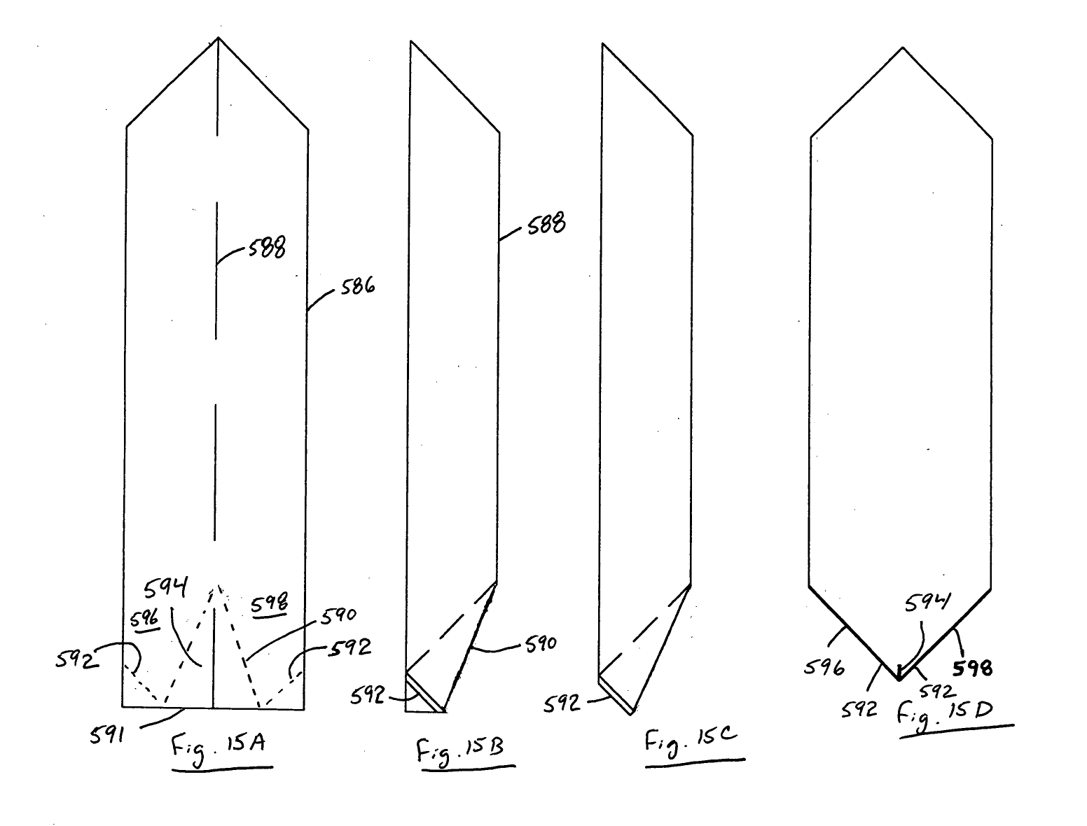

FIGS. 15A-D show one way in which the fiber cushion 504 may be prepared from a generally two-dimensional fiber cushion piece 586 to a generally three-dimensional piece 502 of spreading material shown in FIG. 13. Piece 586 includes a rectangular portion and triangular portion. Piece 586 may then be folded along a middle fold line 588. Then piece 586 can be folded along a fold line 590, as shown in FIG. 15B. Then piece 586 can be cut at line 592, as shown in FIG. 15C. Then piece 586 can be unfolded along fold line 588 and two triangular portions 594, where each of the triangular portions is bounded by middle fold line 588, fold line 590, and end line 591 can be drawn in and upwardly to an inside of a boat-like piece of spreading material 502 having spreading faces 596, 598. In such a form, cut lines 592 are generally aligned with each other. In such a form, triangular portions 594 may be trimmed and sonically welded together such that piece 586 is locked into the boat-like form or the form that fits to first base portion 508. In such a form, face 596, shown in FIG. 15D, is face 518 shown in FIG. 13. In such a form, face 598, shown in FIG. 15D, is face 504 shown in FIG. 13. The three-dimensional boat-like form is shown in FIG. 13.

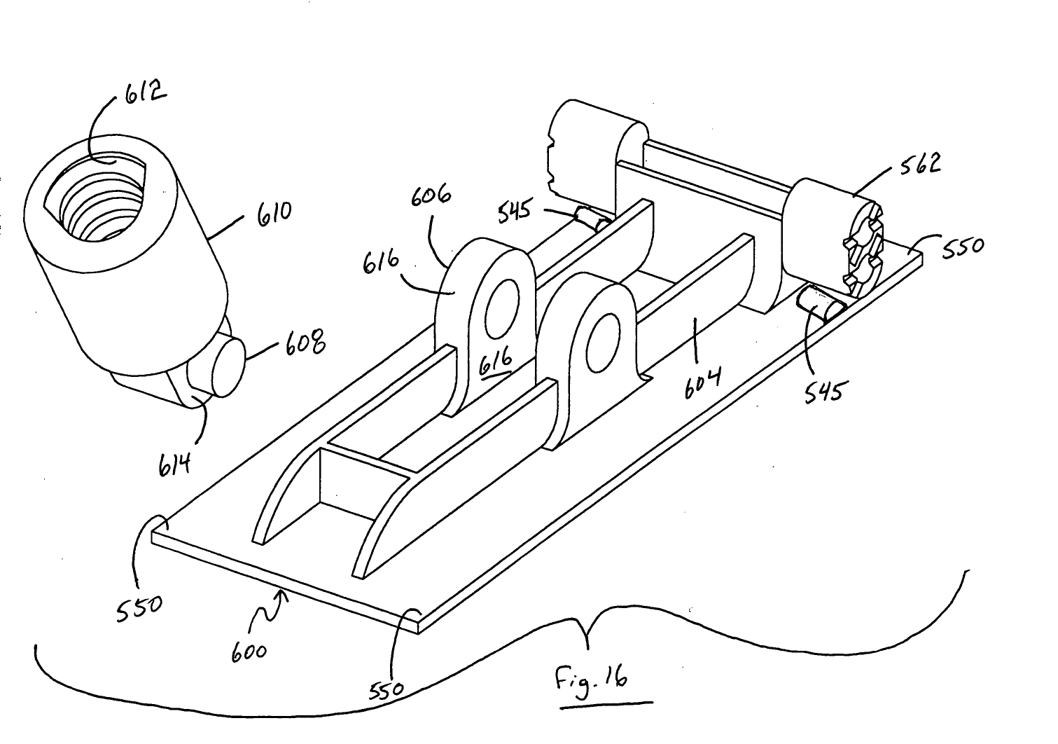

FIG. 16 is an alternate form of the second base portion and is indicated by reference numeral 600. Second base portion 600 includes a flat section 602 that is rectangular in shape and that includes rails 550 and nubs 545 that engage the tracks 542 and nub receptors 543. Second base portion 512 may be slid from first base portion 508 and second base portion 600 may be slid into first base portion 508. Second base portion 600 further includes a framework 604 integral with flat section 602. Integrally mounted on the framework 604 is the pair of shroud pin receptor housings 562. Further integrally mounted on the framework 604 is a pair of pin receptors 606 for receiving pins 608 of a cylindrical receptor 610 for receiving an elongate extension or stick. Cylindrical receptor 610 includes a threaded receptacle 612 for receiving a threaded end of an extension or stick, perhaps three to ten feet long or even longer, such that, when the extension is fixed in receptor 610, which is mounted between pin receptors 606 of second base portion 600, which carries the first base portion 508 having fiber cushion 504, a ceiling or upper portions of high walls may be painted.

It should be noted that faces 614 of receptor 610 confront faces 616 of pin receptors 606 to minimize side to side wobble of second base portion 600. Further, framework 604 is relatively open to permit a wide range of swinging of the receptor 610 relative to receptor 606, and the annular face 616 permits such. Second base portion 600 is a molded piece such that opposite pin receptors 606 may be drawn apart resiliently for reception and disengagement of pins 608.

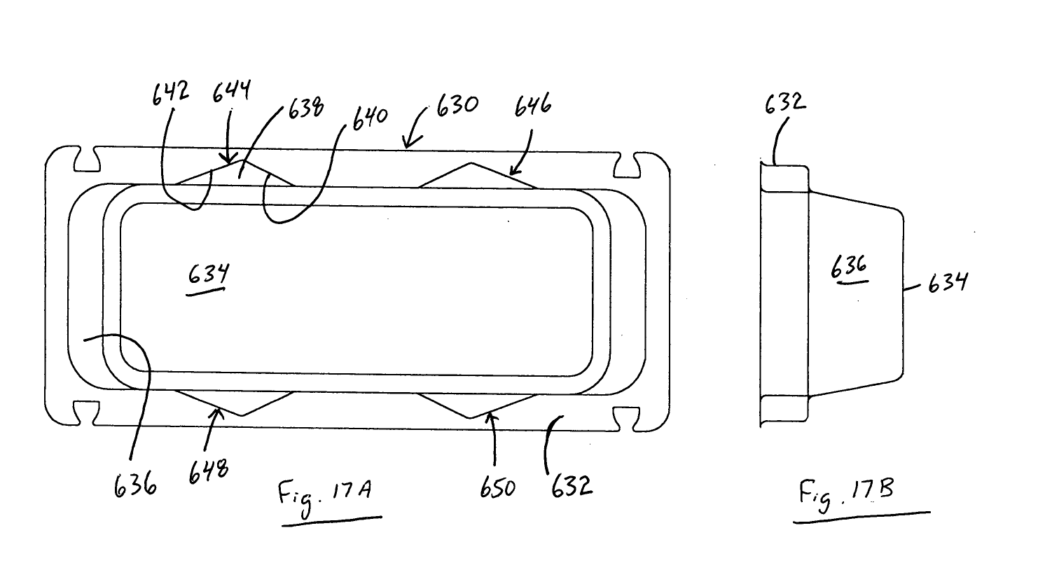

FIG. 17A shows a diagrammatic top view of a paint tray 630 and FIG. 17B shows a diagrammatic end view. Paint tray 630 includes an upper peripheral lip 632, a floor 634, and a side wall 636 between the lip 632 and the floor 634. Formed in the lip 632 and, if desired, partially in wall 636, are indents 644, 646, 648 and 650 where each of such indents is formed by a floor 638 and a pair of faces 640, 642 set at an angle relative to each other. Each of the indents 644, 646, 648, 650 may receive a portion of spreader 200 or spreader 500 where, for example, indents 644 and 650 each receive corners of a spreader and such spreader is rested angularly across the lip 632 of the tray 630 to permit drippings to fall into tray 630. Likewise, indents 646, 648 may pair up to receive corners of a spreader. The engaged corners of the spreader are the “kitty-korner” portions of the spreader, particularly the fiber cushion corners of the spreading material of the spreader.

The peripheral lip 632 of the paint tray 630 includes a set of four dovetail shaped cutouts 652 for the insertion of one or more straps such that tray 630 may be carried up a ladder or across the room and back again. The straps may cross the top of the paint tray 630 in an X arrangement such that the straps intersect at one point and such that the tray 630 may be hung from such one point from a hook at the top of a ladder.

1. A slideable nonrolling spreader, comprising:
a) a body having a base and a handle, wherein the base comprises a pair of ends that define a length and a pair of sides that define a width, with the base further comprising a floor;
b) spreading material engaged at least on the floor of the base and disposed opposite of the handle such that, via the handle, the spreading material can work upon a surface, with the spreading material having a length and a width, with the length of the spreading material being generally the length of the base such that the spreading material extends generally from end to end of the base, and with the width of the spreading material being generally the width of the base such that the spreading material extends generally from side to side of the base, such that said spreading material is relatively long and relatively wide to load and unload a relatively great amount of paint and to come into contact with a relatively great amount of said surface at once and such that pressure upon the base translates immediately to pressure upon said spreading material which in turn translates immediately to pressure upon said surface being worked upon;
c) wherein the spreading material comprises a noncell and nonfoam fiber cushion, wherein the fiber cushion comprises a network of fibers, with some of the fibers running in a direction toward and away from said floor, and with some of the fibers running in a direction crosswise relative to said floor;
d) with the noncell and nonfoam fiber cushion being one of i) generally planar between the sides and ii) slightly curved between the sides; and
e) wherein the spreading material includes a depth, with the depth of the spreading material being less than each of the width and length of the spreading material.

2. The slideable nonrolling spreader of claim 1, wherein one of the ends of the base is designated a first end, with the first end having two faces extending at generally right angles relative to each other and at generally a right angle relative to the floor of the base, with the slideable nonrolling spreader further comprising spreading material engaged at least partially on said faces of the first end, whereby said first end is a corner spreader end.

3. The slideable nonrolling spreader of claim 1, wherein one of the ends of the base is designated a second end, with the second end having two faces extending at generally right angles relative to each other and at generally a right angle relative to the floor of the base, with the spreading material terminating immediately at floor portions leading immediately into said faces of the second end, and with said two faces of the second end being free of said spreading material, whereby said second end is an edger end.

4. The slideable nonrolling spreader of claim 1:
a) wherein one of the ends of the base is designated a first end, with the first end having two faces extending at generally right angles relative to each other and at generally a right angle relative to the floor of the base, with the slideable nonrolling spreader further comprising spreading material engaged at least partially on said faces of the first end, whereby said first end is a corner spreader end; and
b) wherein another end of the base is designated a second end, with the second end having two faces extending at generally right angles relative to each other and at generally a right angle relative to the floor of the base, with the spreading material terminating immediately at floor portions leading immediately into said faces of the second end, and with said two faces of the second end being free of said spreading material, whereby said second end is an edger end.

5. The slideable nonrolling spreader of claim 1, and further comprising a shroud, with the shroud being engaged with the body, with the shroud having an inner face and an edge, with the spreading material including an end, with the shroud movable to an operating position where the inner face of the shroud confronts said end of the spreading material and where the edge is disposed beyond the floor of the base and confronts said end of the spreading material, and with the shroud being movable to an out-of-the-way position where the inner face and edge of the shroud is out-of-the-way of said end of the spreading material.

6. The slideable nonrolling spreader of claim 5, with the shroud being pivotally engaged to the body.

7. The slideable nonrolling spreader of claim 1, wherein the body includes a neck disposed between the handle and the base, with the neck having a width less than a width of each of the handle and the base, with each of the handle, neck and base being elongate in a first direction.

8. The slideable nonrolling spreader of claim 1, wherein the handle, base and spreading material are elongate in a first direction, wherein the handle confronts the base which in turn confronts the spreading material such that control of the handle translates immediately to control of the spreading material and such that, with pressure on the handle, said pressure is relatively close to said surface being worked upon such that said spreading material breaks through dirt and dust on said surface and applies coating directly to said surface instead of to dirt and dust on said surface.

9. The slideable nonrolling spreader of claim 1, wherein the spreading material comprises a periphery having at least two generally straight edges, with said two generally straight edges meeting at a point, with an angle between said two generally straight edges being greater than ninety degrees such that a wake or plow effect with a coating upon said surface is minimized.

10. The slideable nonrolling spreader of claim 1, wherein the spreading material comprises a periphery having an edge, with a portion of said edge being curved such that a wake or plow effect with a coating upon said surface is minimized.

11. The slideable nonrolling spreader of claim 1, wherein the spreading material is selected from the group of spreading materials consisting of woven spreading materials, polyester spreading materials, lint free and woven polyester spreading materials, knitted polyester spreading materials, wool spreading materials, and knitted polyester and wool spreading materials.

12. The slideable nonrolling spreader of claim 1, wherein the base comprises a first base portion and a second base portion, with the first and second base portions being readily engagable to and disengagable from each other, with the first base portion being engaged to the spreading material which includes the fiber cushion, with the second base portion being engaged to the handle.

13. The slideable nonrolling spreader of claim 12, wherein the first and second base portions are slideable relative to each other to engage and disengage the first and second base portions.

14. The slideable nonrolling spreader of claim 1, wherein the base includes a rectangular portion and two generally triangular portions, with the triangular portions being opposite of each other, with each of the triangular portions being set at opposite ends of the rectangular portion, such that one of the triangular portions forms a support for a corner spreader end and such that the other of the triangular portions forms a support for an edger end.

15. The slideable nonrolling spreader of claim 1, with prior to fibers of the fiber cushion being coated, said fibers having a given drag upon a given surface with a given pressure, and further comprising a drag reducing coating on each of the fibers such that said given drag upon said given surface with said given pressure is reduced.
